(19) United States
(12) Patent Application Publication
(10) Pub. No.: US 2002/0061827 A1
(43) Pub. Date: May 23, 2002

(54) Aqueous liquids comprising a surfactant and an acetal

(75) Inventors: Dennis Miller, Kelkheim (DE); Franz Xaver Scherl, Burgkirchen (DE); Werner Skrypzak, Hofheim/Ts. (DE); Eva-Maria Wiener, Hofheim-Diedenbergen (DE)

Correspondence Address: CLARIANT CORPORATION, 4331 CHESAPEAKE DR, ATTN: INDUSTRIAL PROPERTY DEPT, CHARLOTTE, NC, 28216, US

(73) Assignee: Clariant GmbH

(21) Appl. No.: 09/943,469

(22) Filed: Aug. 30, 2001

(30) Foreign Application Priority Data
Aug. 30, 2000 (DE) 10042514.3

(51) Int. Cl. C11D 17/00

(52) U.S. Cl. 510/417

(57) ABSTRACT

Aqueous liquids comprising a surfactant and an acetal. It has now surprisingly been found that readily biodegradable acetals are outstandingly suitable as solubility promoters in microemulsions and liquid-crystalline phases. On the basis of homogeneous single-phase liquids consisting of acetal and surfactant, it is also possible to prepare formulations without the addition of cosurfactants.

### BACKGROUND OF THE INVENTION

The invention relates to aqueous liquids which are in the form of stable micro-emulsions and also in the form of homogeneous liquid-crystalline phases and which comprise one or more surfactants, and one or more water-insoluble acetal(s) and/or ketals, and to the use thereof as laundry detergents and cleaners, in particular for hard surfaces.

The compositions according to the invention are characterized in dilute form and also in concentrated form by transparency, phase stability in a wide temperature range, favorable viscosity properties and a high cleaning power, in particular in the case of hydrophobic soil which is difficult to remove, for example grass, grease and oil, ballpoint pen inks, felt tip pen inks etc.

### FIELD OF THE INVENTION

Liquid cleaners for hard surfaces such as metal, glass, ceramic, plastic and linoleum have the advantage over solid compositions that they can be applied to the soil in high active concentrations in a very user-friendly manner and very efficiently detach soilings without leaving cleaning streaks and films on shiny surfaces. Cleaners in the form of emulsions, in particular microemulsions, are preferably used for removing organic soilings. Microemulsions have significant advantages over traditional emulsions with regard to clarity and homogeneity of the compositions.

Applications of microemulsions or liquid-crystalline phases are also known as formulations for crop protection, cosmetics and pharmacy, for increasing the yield in the recovery of petroleum, as degreasing agents, as cooling lubricants, as new types of solvents, for example for dyes, as reaction medium and in emulsion polymerization.

Depending on the use, low-viscosity sprayable microemulsions or viscose, liquid-crystalline phases are desired.

Microemulsions comprise one or more water-insoluble solvents in addition to surface-active substances. The prior art covers the use of water-insoluble aliphatic, aromatic or halogenated hydrocarbons, in particular of isoparaffins and terpenes, optionally with further polar solvents, in most cases in combination with cosurfactants, for example alcohols or ethoxylates (EP 368 146, U.S. Pat. No. 6,048,834).

### SUMMARY OF THE INVENTION

An objective is to develop consumer-friendly compositions, in particular for the cleaning of hard surfaces, which are efficient and environmentally compatible.

It has now surprisingly been found that readily biodegradable acetals are outstandingly suitable as solubility promoters in microemulsions and liquid-crystalline phases. On the basis of homogeneous single-phase liquids consisting of acetal and surfactant, it is also possible to prepare formulations without the addition of cosurfactants.

### DESCRIPTION OF THE PREFERRED EMBODIMENTS

The invention provides aqueous liquids which comprise surfactants and acetals.

The term acetals is intended here to also include ketals and ortho esters. Suitable compounds of this type are, in particular, those of the formula

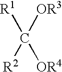

in which R¹ is C₁-C₂₄-alkyl, C₂-C₂₄-alkenyl, C₁-C₄-alkoxy-C₂-C₄-alkyl, benzyl, phenyl, C₁-C₄-alkylphenyl, C₁-C₄-alkoxyphenyl, C₆-C₈-cycloalkyl, C₁-C₄-alkyl-C₆-C₈ cycloalkyl or a group —OR³ or —OR⁴, or R¹ is a group of the formula

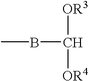

where B is a direct bond, C₁-C₂-alkylene, C₂-hydroxyalkylene or —CH═CH—, and

R² is hydrogen at the same time,

R² is hydrogen or has the same meaning as R¹,

R³ and R⁴ are a group of the formula -(AO)x—R where A is —C₂H₄—, —C₃H₇— or —C₄H₈—, x is a number from 0 to 4 and R is C₁-C₂₄-, preferably C₁-C₄-alkyl, or C₂-C₂₄-, preferably C₂-C₄-alkenyl, or R³ and R⁴ are amino-C₂-C₄-alkyl, C₂-C₄-dialkylamino-C₂-C₄-alkyl, -hydroxy-C₂-C₆-alkyl, benzyl, phenyl, C₁-C₄-alkylphenyl, C₁-C₄-alkoxyphenyl, C₆-C₈-cycloalkyl, C₁-C₄-alkyl-C₆-C₈-cycloalkyl or tetrahydrofurfuryl, or R³ and R⁴ together are a group of the formulae

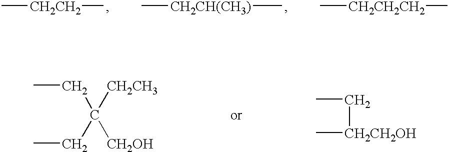

These compounds are obtained by reacting an aldehyde or a ketone with a hydroxy compound, in particular mono- or polyalcohols, under acidic conditions by cleaving off water. The term aldehydes also includes dialdehydes, for example glyoxal and the dialdehydes of tartaric acid, succinic acid, maleic acid, fumaric acid. Suitable radicals R¹ and R² are, for example, C₁-C₁₈-alkyl, preferably C₁-C₁₂-alkyl, C₂-C₁₂-alkenyl, cyclohexyl, cycloheptyl, cyclooctyl, 2-methylcycloheptyl, 3-butylcyclohexyl, 3-methylcyclohexyl, phenyl or benzyl.

Suitable for the preparation of the acetals, ketals or ortho esters used according to the invention are, for example, mono- or polyhydroxy compounds having 2 to 20 OH groups, alkanolamines, alkoxylated (EO and/or PO) alcohols, carboxylated, acylated and/or ether-containing mono- or polyols having saturated or unsaturated, linear or branched alkyl or alkenyl end-groups having 1 or 2 to 24 carbon atoms, respectively and preferably 4 to 12 carbon atoms, which may be substituted by O, N or S-containing groups, but also by cyclic or aromatic groups. Examples of polyhydroxy compounds are mono-, di- or trihydroxy compounds, such as methyl alcohol, ethyl alcohol, n-propyl alcohol, n-butyl alcohol, isobutyl alcohol, sec-butyl alcohol, glycerol, trimethylolpropane, amyl alcohol, octyl alcohol, ethylhexyl alcohol, decyl alcohol, and octadecyl alcohol. Suitable cyclic alcohols are tetrahydrofurfuryl alcohol, cyclohexanol, cycloheptanol, cyclooctanol, 2-methylcycloheptanol, 3-butylcyclohexanol and 3-methylcyclohexanol. Examples of ether alcohols are C1-C10-alkyl ethers of mono-, di- or triethylene glycol or propylene glycol.

Particularly suitable are acetals having a total of from 3 to 30 carbon atoms, preferably 5 to 15 carbon atoms, particularly preferably compounds prepared from a C₁-C₈-alkyl aldehyde, preferably paraldehyde, butyraldehyde, isobutyraldehyde and 1,2,3-trihydroxypropane or 1,1,1-trimethylolpropane.

Also suitable are acetals from methoxyacetaldehyde and tetrahydrofurfuryl alcohol or mono-, di- or triethylene or -propylene glycol alkyl ethers, and methoxyacetaldehyde di(alkoxydiethoxyethyl) acetal, methoxyacetaldehyde di(alkoxyethyl) acetal, methoxyacetaldehyde di(alkoxyethoxyethyl) acetal, methoxyacetaldehyde di(alkoxydiethoxyethyl) acetal.

The acetals, ketals or ortho esters are obtained by reacting aldehyde or ketone, respectively, and alcohol in the molar ratios1:1 to 1:5, in the manner described in U.S. Pat. No. 2,796,423, U.S. Pat. No. 2,842,499, U.S. Pat. No. 3,563,893, where the reaction participants may be one or more alcohols, and one or more aldehydes or ketones, respectively. The reactants are dissolved in suitable solvents, for example, toluene or other organic solvents and reacted at temperatures in the range of from 85 to 130° C.

The aqueous liquids according to the invention comprise the abovementioned acetals in the amounts from 0.05 to 50% by weight, preferably 1 to 20% by weight, based on the finished composition, and, as second component, one or more surfactants in the amounts by weight of from 0.2 to 30% by weight, preferably from 1 to 20% by weight. These aqueous liquids according to the invention are microemulsions or liquid-crystalline phases which contain the acetals as water-insoluble liquids. These acetals improve the cleaning action of the claimed liquids.

Suitable surfactants are anionic, cationic, nonanionic and amphoteric interface-active substances and combinations of these substances.

Anionic surfactants which may be mentioned are:

C₁₀-C₂₀-alkyl and alkylene carboxylates, alkyl ether carboxylates, fatty alcohol sulfates, fatty alcohol ether sulfates, alkylolamide sulfates and sulfonates, fatty acidalkylolamide polyglycol ether sulfates, acyl esters of isethionates, α-sulfo fatty acid esters, alkylbenzenesulfonates, alkylphenol glycol ether sulfonates, lignosulfonates, sulfosuccinates, sulfosuccinic mono esters and diesters, fatty alcohol ether phosphates, protein fatty acid condensation products, alkyl monoglyceride sulfates and sulfonates, alkyl glyceride ether sulfonates, fatty acid methyl taurides, fatty acid sarcosinates, sulforicinoleates, and acyl glutamates, hydroxyalkanesulfonates, olefinsulfonates. These compounds and mixtures thereof are used in the form of their water-soluble or water-dispersible salts, for example as sodium, potassium, magnesium, ammonium, mono-, di- and triethanolammonium salts, and also the analogous alkylammonium salts. Preference is given to using secondary alkanesulfonates.

Suitable cationic surfactants are, for example, quarternary ammonium salts, such as di-(C₁₀-C₂₄-alkyl) dimethylammonium chloride or bromide, preferably di-(C₁₂-C₁₈-alkyl) dimethylammonium chloride or bromide; C₁₀-C₂₄-alkyldimethylethylammonium chloride or bromide; C₁₀-C₂₄-alkyltrimethylammonium chloride or bromide, preferably cetyltrimethylammonium chloride or bromide and C₂₀-C₂₂-alkyltrimethylammonium chloride or bromide; C₁₀-C₂₄-alkyldimethylbenzylammonium chloride or bromide, preferably C₁₂-C₁₈-alkyldimethylbenzylammonium chloride; N-(C₁₀-C₁₈-alkyl)pyridinium chloride or bromide, preferably N-(C₁₂-C₁₆-alkyl)pyridinium chloride or bromide; N-(C₁₀-C₁₈-alkyl)isoquinolinium chloride, bromide or monoalkyl sulfate; N-(C₁₂-C₁₈-alkylpoylolaminoformylmethyl)pyridinium chloride; N-(C₁₂-C₁₈-alkyl)-N-methylmorpholinium chloride, bromide or monoalkyl sulate; N-(C₁₂-C₁₈-alkyl)-N-ethylmorpholinium chloride, bromide or monoalkyl sulfate; C₁₆-C₁₈-alkylpenta-oxyethylammonium chloride; diisobutyl-phenoxyethoxyethyldimethyl-benzylammonium chloride; salts of N,N-diethylaminoethylstearylamide and -oleylamide with hydrochloric acid, acetic acid, lactic acid, citric acid, phosphoric acid; N-acylamidoethyl-N,N-diethyl-N-methylammonium chloride, bromide or monoalkyl sulfate and N-acylaminoethyl-N,N-diethyl-N-benzylammonium chloride, bromide or monoalkyl sulfate, where acyl is preferably stearyl or oleyl.

Nonanionic surfactants which may be used are: alkylpolyethylene glycols, alkylphenol polyethylene glycols; alkyl mercaptan polyethylene glycols; fatty amin ethoxylates (alkylaminopolyethylene glycols); fatty acid ethoxylates (acylpolyethylene glycols); polypropylene glycol ethoxylates (Pluronic®); fatty acid alkylolamides, (fatty acid amide polyethylene glycols); N-alkyl-, N-alkoxypolyhydroxy fatty acid amides, sucrose esters; sorbitol esters or oxethylated sorbitol esters, preferably fatty alcohol ethoxylates based on C₉-C₁₅-fatty alcohols.

Suitable amphoteric surfactants are, for example: N-(C₁₂-C₁₈-alkyl)-β-aminopropionates and N-(C₁₂-C₁₈-alkyl)-β-iminodipropionates, as alkali metal and mono-, di- and trialkylammonium salts; N-acylamidoalkyl-N,N-dimethylacetobetaine, preferably N-(C₈-C₁₈-acyl)amidopropyl-N,N-dimethylacetobetaines; C₁₂-C₁₈-alkyl-dimethylsulfopropylbetaines; amphoteric surfactants based on imidazoline (trade name: Miranol®, Steinapon®), preferably the sodium salt of 1-(β-carboxy-methyloxyethyl)-1-(carboxymethyl)-2-laurylimidazolinium; amine oxides, e.g. C₁₂-C₁₈-alkyldimethylamine oxide, fatty acid amidoalkyldimethylamine oxides.

Particular preference is given to compositions which comprise anionic and nonionic surfactant. Here, combinations of secondary alkanesulfonates and fatty alcohol ethoxylates based on C₉-C₁₅-fatty alcohols are particularly advantageous.

Moreover, the homogeneous single-phase liquids according to the invention comprise, depending on the intended use, as well as the said acetals and surfactants, also the auxiliaries and additives specific in each case, for example cosurfactants, emulsifiers, solvents, hydrotropes, water-insoluble hydrocarbons, in particular terpenes and/or essential oils, water-insoluble alcohols, esters, ethers, alcohols, ketones and lactones, enzymes, thickeners, electolytes, complexing agents, alkalis, acids, preservatives, dyes, foam inhibitors, sequestering agents, abrasive substances, nonionically and ionically modified soil release polymers, di- or polyvalente metal salts, in particular magnesium and aluminum salts, antistatic substances and bleaching systems.

Suitable cosurfactants are short-chain alcohols, glycols, glycol ethers, pyrrolides and glycol ether esters, alkylbetaines, alkylamidobetaines, aminopropionates, aminoglycinates, imidazoliniumbetaines and sulfobetaines, amine oxides and fatty acid alkanolamides or polyhydroxyamides.

Suitable emulsifiers are addition products of from 2 to 30 mol of ethylene oxide and/or 0 to 5 mol of propylene oxide with linear fatty alcohols having 8 to 22 carbon atoms, with fatty acids having 12 to 22 carbon atoms and with alkylphenols having 8 to 15 carbon atoms in the alkyl group; C₁₂-C₁₈-fatty acid mono-and diesters of addition products of from 1 to 30 mol of ethylene oxide with glycerol; glycerol mono- and diesters and sorbitan mono- and diesters of saturated and unsaturated fatty acids having 6 to 22 carbon atoms and ethylene oxide addition products thereof; addition products of from 15 to 60 mol of ethylene oxide with castor oil and/or hydrogenated caster oil; polyol esters and, in particular polyglycerol esters, such as, for example, polyglycerol polyricinoleate and polyglycerol poly-12-hydroxystearate. Also suitable are mixtures of compounds of two or more of these classes of substance. The addition products of ethylene oxide and/or propylene oxide with fatty alcohols, fatty acids, alkylphenols, glycerol mono- and diesters, and sorbitan mono- and diesters of fatty acids or with castor oil are known, commercially available products. They are homolog mixtures whose average degree of alkoxylation corresponds to the ratio of the amounts of ethylene oxide and/or propylene oxide and substrate with which the addition reaction is carried out. Furthermore, it is possible to use emulsifiers obtained by transesterification of optionally oxalkylated sorbitol with fatty acid methyl esters or fatty acid triglycerides and optionally oxalkylation of the reaction products obtained by transesterification with fatty acid methyl esters. In principle, suitable solvents are all mono- or polyhydric alcohols. Preference is given to using alcohols having 1 to 4 carbon atoms, such as methanol, ethanol, propanol, isopropanol, straight-chain and branched butanol or glycerol and mixtures of said alcohols. Further preferred alcohols are polyethylene glycols having a relative molecular mass below 2000. In particular, a use of polyethylene glycol having a relative molecular mass between 200 and 600 and in amounts up to 45% by weight, and of polyethylene glycol having a relative molecular mass between 400 and 600 in amounts of from 5 to 25% by weight is preferred. Further suitable solvents are, for example, benzyl alcohol, ethylene glycol monobutyl ether, propylene glycol monobutyl ether, diethylene glycol monobutyl ether, propylene glycol monotert-butyl ether, triacetine (glycerol triacetate) and 1-methoxy-2-propanol.

Hydrotropes are short-chain alkylarylsulfonates, triethanolamine, urea, C₄-C₁₂-alkyl esters, alkylenedicarboxylic acids, optionally neutralized, and alkylenedicarboxylic anhydrides.

Suitable water-insoluble components are hydrocarbons, in particular paraffins and terpenes, oils, for example stone-pine oil, balsam oil, citrus oil, orange oil, lime oil, bergamot oil, esters, for example phenoxyethyl isobutyrates, benzyl acetates, p-tert-butylcyclohexyl acetate, dimethylcarbinyl acetates, phenylethyl acetate, ethylmethylphenyl glycinates, benzyl salicylate, and also ethers, for example benzyl-ethyl ether, aldehydes, for example C₈-C₁₈-alkyl aldehydes, alkcohols, for example anethole, citronellol, eugenol, geraniol, linalool, phenylethyl alcohol, terpenol, ketones for example methyl cedryl ketone, lactones, for example gamma-C₈-C₁₄-alkyl lactones, pyrrones, for example hydroxy-C₁-C₄-alkylpyrrones and pyrroles, for example benzopyrroles.

As thickeners, preference is given to using hydrogenated castor oil, salts of long-chain fatty acids, preferably in amounts of from 0 to 5% by weight and in particular in amounts of from 0.5 to 2% by weight, for example sodium, potassium, aluminum, magnesium and titanium stearates or the sodium and/or potassium salts of behenic acid, and polysaccharides, in particular xanthan gum, guar-guar, agar-agar, alginates and tyloses, carboxymethylcellulose and hydroxyethylcellulose, and also relatively high molecular weight polyethylene glycol mono- and diesters of fatty acids, polyacrylates, polyvinyl alcohol and polyvinylpyrrolidone, and electrolytes, such as sodium chloride and ammonium chloride.

Suitable enzymes are those from the class of proteases, lipases, amylases and mixtures thereof. Their proportion can be 0.2 to 1% by weight. The enzymes can be adsorbed to carrier substances and/or embedded in coating substances.

In order to bind traces of heavy metals, the salts of polyphosphoric acids, such as 1-hydroxyethane-1,1-diphosphonic acid (HEDP) and diethylenetriaminepentamethylenephosphonic acid (DTPMP), can be used.

Suitable preservatives are, for example, phenoxyethanol, formaldehyde solution, parabens, pentanediol or sorbic acid. Furthermore, the compositions according to the invention can comprise alkali, for example sodium hydroxide solution, ammonia and/or alkanolamines having up to 9 carbon atoms, preferably ethanolamine, in particular triethanolamine. In addition to the alkali, the compositions may comprise acids, in particular mono-, di- or polycarboxylic acids having up to 6 carbon atoms, for example acetic acid, citric acid, lactic acid, glycolic acid, succinic acid or adipic acid.

In a particular embodiment, the liquids according to the invention can comprise, as further additives, alkoxylated dihydroxyaromatic compounds for reducing the rain and/or mist effect and/or substantial polymers with hydrophilic groups, as described in DE 198 59 808.

Further preferred additives are anionic and/or nonionic and/or terminally capped oligo esters, referred to as ‘soil release polymers’, comprising dicarboxylic acid units, for example terephthalic acid, phthalic acid, isophthalic acid and esters thereof, for example diethyl oxalate, diethyl succinate, diethyl glutarate or anhydrides, for example maleic anhydride, phthalic anhydride or succinic anhydride and diol units (glycol, alkylglycol and/or polyalkylene glycol units), as described in EP 442 101, EP 241 985 and EP 253 567. Suitable abrasive substances are silicates, calcium carbonate, wood flour and/or plastics flour.

Suitable salts or extenders are, for example, sodium sulfate, sodium carbonate and sodium silicate (waterglass). Typical individual examples of further additives are sodium borate, starch, sucrose, polydextrose, TAED, stilbene compounds, methylcellulose, toluenesulfonate, cumenesulfonate, soaps and silicones.

The liquids according to the invention can comprise, as foam inhibitors, fatty acid alkyl ester alkoxylates, organopolysiloxanes and mixtures thereof with microfine, optionally silanized silicic acid, and also paraffins, waxes, microcrystalline waxes and mixtures thereof with silanized silicic acid. Mixtures of different foam inhibitors can also advantageously be used, e.g. those of silicone oil, paraffin oil or waxes.

The desired viscosity of the composition can be adjusted by adding water and/or organic solvents or by adding a combination of organic solvents and thickeners.

The examples and applications below serve to illustrate the invention in more detail, without, however, limiting it thereto.

### EXAMPLES

Example 1: Liquid-crystalline phase

| | | |
|---|---|---|
| Hostapur SAS 60 | 6.75% | by weight |
| Genapol UD 030 | 12.15% | by weight |
| Acetal I | 8.0% | by weight |
| Demin. water | 100% | by weight |

Example 2: Liquid-crystalline phase

| | | |
|---|---|---|
| Hostapur SAS 60 | 17.55% | by weight |
| Genapol UD 030 | 5.67% | by weight |
| Acetal II | 8.0% | by weight |
| Demin. water | 100% | by weight |

Example 3: Microemulsion

| | | |
|---|---|---|
| Hostapur SAS 60 | 17.55% | by weight |
| Genapol UD 030 | 5.67% | by weight |
| Acetal I | 8.0% | by weight |
| Demin. water | 100% | by weight |

Preparation procedure:

The components are mixed, with stirring, in any order at room temperature.

Chemical names of the products used:

| | |
|---|---|
| Hostapur SAS 60 | sec. alkanesulfonate, 60% strength |
| Genapol UD 030 | C₁₁-oxo alcohol + 3 EQ |
| Acetal I | Reaction product of paraldehyde and |
| | 1,1,1-trimethylolpropane |
| Acetal II | Reaction product of isobutyraldehyde and |
| | 1,1,1-trimethylolpropane |

1. An aqueous liquid comprising a surfactant and an acetal.

2. The aqueous liquid as claimed in claim 1, which comprises, as acetal, a compound of the formula 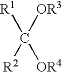
in which R¹ is C₁-C₂₄-alkyl, C₂-C₂₄-alkenyl, C₁-C₄-alkoxy-C₂-C₄-alkyl, benzyl, phenyl, C₁-C₄-alkylphenyl, C₁-C₄-alkoxyphenyl, C₆-C₈-cycloalkyl, C₁-C₄-alkyl-C₆-C₈-cycloalkyl or a group —OR³ or —OR⁴, or R¹ is a group of the formula 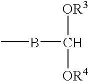
where B is a direct bond, C₁-C₂-alkylene, C₂-hydroxyalkylene or —CH═CH—, and
R² is hydrogen at the same time,
R² is hydrogen or has the same meaning as R¹,
R³ and R⁴ are a group of the formula -(AO)ₓ—R where A is —C₂H₄—, —C₃H₇— or —C₄H₈—, x is a number from 0 to 4 and R is C₁-C₂₄-, preferably C₁-C₄-alkyl, or C₂-C₂₄-, preferably C₂-C₄-alkenyl, or R³ and R⁴ are amino-C₂-C₄-alkyl, C₂-C₄-dialkylamino-C₂-C₄-alkyl, -hydroxy-C₂-C₆-alkyl, benzyl, phenyl, C₁-C₄-alkylphenyl, C₁-C₄-alkoxyphenyl, C₆-C₈-cycloalkyl, C₁-C₄-alkyl-C₆-C₈-cycloalkyl or tetrahydrofurfuryl, or R³ and R⁴ together are a group of the formulae

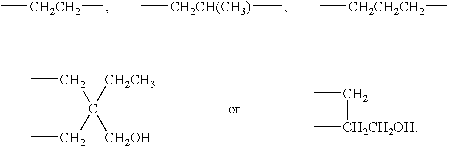

3. The aqueous liquid as claimed in claim 1, which comprises a compound of the formula 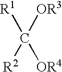
in which R¹ is C₁-C₁₂-alkyl, R² is hydrogen and R³ and R⁴ together are a group of the formulae

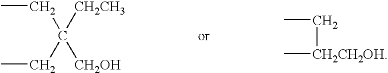

4. The use of the aqueous liquid as claimed in claim 1 as laundry detergents and cleaners.
